(19) United States
(12) Patent Application Publication
(10) Pub. No.: US 2019/0003423 A1
(43) Pub. Date: Jan. 3, 2019

(54) DUAL-EXPANDER SHORT-LENGTH AEROSPIKE ENGINE

(71) Applicant: EXQUADRUM, INC., Adelanto, CA (US)

(72) Inventor: Philip C. Pelfrey, Adelanto, CA (US)

(21) Appl. No.: 15/412,548

(22) Filed: Jan. 23, 2017

(51) Int. Cl. F02K 9/97; F02K 9/48; F02K 9/58; F02K 9/62

(52) U.S. Cl. CPC F02K 9/972; F02K 9/48; F05D 2240/128; F02K 9/62; F02K 9/58

(57) ABSTRACT

A dual-expander, truncated aerospike rocket engine includes an aerospike nozzle with an oxidizer-cooled nozzle section and a fuel-cooled nozzle section. The engine further includes a fuel pump, an oxidizer pump, and a thrust source. The thrust source combusts fuel and oxidizer in a combustion chamber(s) of a thrust source arranged around the aerospike nozzle. Fuel and oxidizer pumps that pump the fuel and the oxidizer through the nozzle sections are driven by respective turbines.

### FIELD

A rocket engine for use in a propulsion system for flight vehicles, such as aircraft, missiles, satellites, and other vehicles that rely on rocket propulsion.

### BACKGROUND

Modern liquid propellant rocket engines such as the Pratt & Whitney RL10B typically use a single expander cycle and a bell nozzle. This design has several limitations that compromise reliability and increase size and weight. For example, these rocket engines require the use of an interpropellant seal (IPS), which is a high-risk component, providing a failure point that limits reliability. Another limitation for standard rocket engines in upper stage applications is that the expansion ratio requirements for operation in the vacuum of space requires bell nozzles to be very long, increasing the size and weight of such rocket engines, thus limiting the possible payload and/or propellant that can be carried by the rocket engine. These issues regarding size, weight and reliability are made more acute by the requirement that single-expander bell nozzle rocket engines use multi-stage pumps in order to increase chamber pressure to reduce the size of the engine instead of lighter, more reliable and higher-performance single-stage pumps that are possible with a dual-expander truncated or short-length aerospike engine described herein.

### SUMMARY

A dual-expander, truncated or short-length aerospike rocket engine providing size- and weight-efficient performance in a vacuum is described herein. The engine includes an aerospike nozzle with an oxidizer, such as oxygen, cooled nozzle section and a fuel, such as hydrogen, cooled nozzle section. The rocket engine further includes a hydrogen pump, an oxygen pump, and a thrust source. The thrust source combusts hydrogen and oxygen, either in an annular combustion chamber or within multiple thrust cells which may be arranged around the aerospike nozzle. The hydrogen and oxygen pumps drive liquid hydrogen and liquid oxygen through the hydrogen-cooled nozzle section and the oxygen-cooled nozzle section respectively, before being combusted in the thrust source. The pumps may be powered by turbines that are driven by the hydrogen and oxygen from the hydrogen-cooled nozzle section and the oxygen-cooled nozzle section. The pumps may be single-stage turbopumps. Size and weight savings provided by the rocket engine described herein directly increases the payload that can be carried by a given rocket engine of a particular performance level, and increasing reliability further reduces risk and thus reduces the cost of delivering payloads into orbit using the described rocket engine.

In one embodiment, a rocket engine described herein can include a truncated aerospike nozzle having a first end and a second end, a fuel-cooled nozzle section between the first end and the second end, and an oxidizer-cooled nozzle section between the first end and the second end. A fuel inlet is in fluid communication with the fuel-cooled nozzle section to permit introduction of fuel into the fuel-cooled nozzle section, and a fuel outlet is formed in the truncated aerospike nozzle that allows fuel to leave the fuel-cooled nozzle section. An oxidizer inlet is in fluid communication with the oxidizer-cooled nozzle section to permit introduction of oxidizer into the oxidizer-cooled nozzle section, and an oxidizer outlet is formed in the truncated aerospike nozzle that allows oxidizer to leave the oxidizer-cooled nozzle section. In addition, a fuel pump is in fluid communication with the fuel inlet to pump fuel into the fuel-cooled nozzle section, and an oxidizer pump is in fluid communication with the oxidizer inlet to pump oxidizer into the oxidizer-cooled nozzle section. A thrust source is disposed on the truncated aerospike nozzle adjacent to the first end and that surrounds the truncated aerospike nozzle, where the thrust source includes a first inlet that is in fluid communication with the fuel outlet and a second inlet that is in fluid communication with the oxidizer outlet. The thrust source has a combustion chamber that receives fuel from the first inlet and oxidizer from the second inlet, and a combustion gas outlet in fluid communication with the combustion chamber that discharges combustion gas onto an outer surface of the truncated aerospike nozzle.

In another embodiment, a rocket engine described herein can include a truncated aerospike nozzle having a first end and a second end, an interior space between the first end and the second end, a fuel-cooled nozzle section between the first end and the second end, and an oxidizer-cooled nozzle section between the first end and the second end. A fuel inlet is in fluid communication with the fuel-cooled nozzle section to permit introduction of fuel into the fuel-cooled nozzle section, and a fuel outlet is formed in the truncated aerospike nozzle that allows fuel to leave the fuel-cooled nozzle section. An oxidizer inlet is in fluid communication with the oxidizer-cooled nozzle section to permit introduction of oxidizer into the oxidizer-cooled nozzle section, and an oxidizer outlet is formed in the truncated aerospike nozzle that allows oxidizer to leave the oxidizer-cooled nozzle section. In addition, a single-stage fuel turbopump is in fluid communication with the fuel inlet to pump fuel into the fuel-cooled nozzle section, where the single-stage fuel turbopump is disposed entirely within the interior space. Likewise, a single-stage oxidizer turbopump is in fluid communication with the oxidizer inlet to pump oxidizer into the oxidizer-cooled nozzle section, where the single-stage oxidizer turbopump is disposed entirely within the interior space. A plurality of thrust cells are disposed on the truncated aerospike nozzle adjacent to the first end and that surround the truncated aerospike nozzle, where each of the thrust cells includes a first inlet that is in fluid communication with the fuel outlet and a second inlet that is in fluid communication with the oxidizer outlet. Each of the thrust cells further includes a combustion chamber that receives fuel from the first inlet and oxidizer from the second inlet, and a combustion gas outlet in fluid communication with the combustion chamber that discharges combustion gas onto an outer surface of the truncated aerospike nozzle.

In still another embodiment, a rocket engine described herein can include an aerospike nozzle having a first end and a second end, an interior space between the first end and the second end, a hydrogen fuel-cooled nozzle section between the first end and the second end, and an oxygen-cooled nozzle section between the first end and the second end. A liquid hydrogen fuel inlet is in fluid communication with the hydrogen fuel-cooled nozzle section to permit introduction of liquid hydrogen fuel into the hydrogen fuel-cooled nozzle section, and a hydrogen fuel outlet is formed in the aerospike nozzle that allows hydrogen fuel to leave the hydrogen fuel-cooled nozzle section. Further, a liquid oxygen inlet is in fluid communication with the oxygen-cooled nozzle section to permit introduction of liquid oxygen into the oxygen-cooled nozzle section, and an oxygen outlet is formed in the aerospike nozzle that allows oxygen to leave the oxygen-cooled nozzle section. A first turbopump assembly includes a single-stage hydrogen turbopump and a first turbine, where the single-stage hydrogen turbopump is in fluid communication with the liquid hydrogen fuel inlet to pump liquid hydrogen fuel into the hydrogen fuel-cooled nozzle section, and the first turbine is mechanically coupled to the single-stage hydrogen turbopump so that the first turbine drives the single-stage hydrogen turbopump. In addition, a second turbopump assembly includes a single-stage oxygen turbopump and a second turbine, where the single-stage oxygen turbopump is in fluid communication with the liquid oxygen inlet to pump liquid oxygen into the oxygen-cooled nozzle section, and the second turbine is mechanically coupled to the single-stage oxygen turbopump so that the second turbine drives the single-stage oxygen turbopump. Both the first turbopump assembly and the second turbopump assembly are disposed entirely within the interior space. A plurality of thrust cells are disposed on the aerospike nozzle adjacent to the first end and that surround the aerospike nozzle. Each of the thrust cells includes a first inlet and a second inlet, and each of the thrust cells further includes a combustion chamber that receives fuel from the first inlet and oxidizer from the second inlet, and a combustion gas outlet in fluid communication with the combustion chamber that discharges combustion gas onto an outer surface of the aerospike nozzle. The first turbine includes an inlet that is in fluid communication with the hydrogen fuel outlet and an outlet that is in fluid communication with the first inlets of the thrust cells, and the second turbine includes an inlet that is in fluid communication with the oxygen outlet and an outlet that is in fluid communication with the second inlets of the thrust cells.

### DRAWINGS

FIG. 1 is a schematic depiction of an example rocket engine and operation cycle described herein.

FIG. 2 is a side view of the exterior of an example rocket engine described herein.

FIG. 3A is a top view of the rocket engine in FIG. 2.

FIG. 3B is a cross-sectional side view of the rocket engine in FIG. 2.

FIG. 3C is another cross-sectional side view of the rocket engine in FIG. 2 viewed from a different angle.

FIGS. 4A and 4B are a to-scale comparison of the rocket engine described herein (FIG. 4A) compared to a single-expander bell nozzle engine (FIG. 4B) of similar performance.

### DETAILED DESCRIPTION

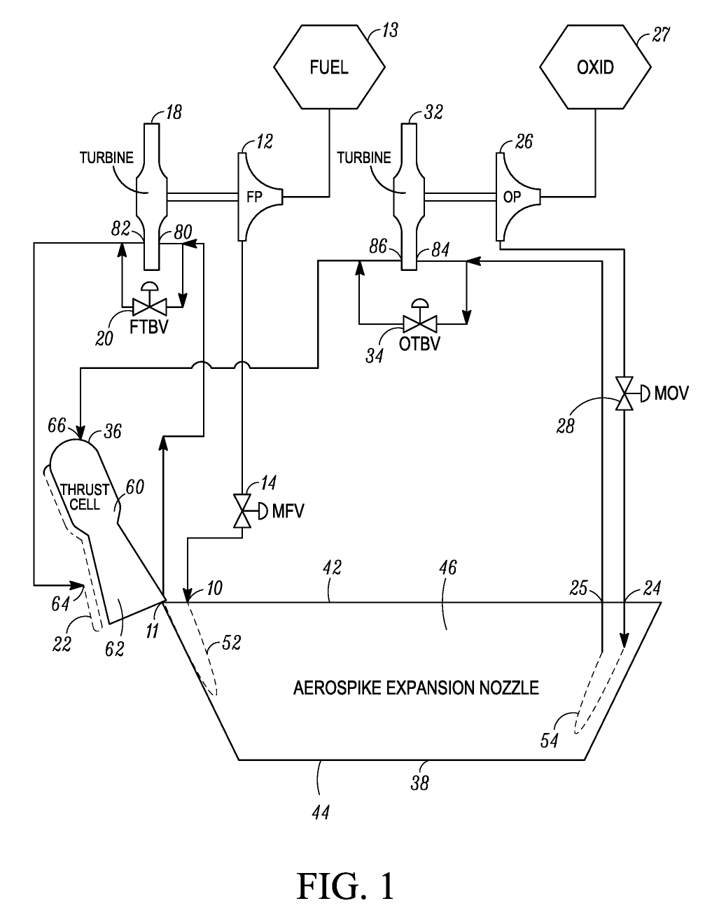

FIG. 1 is a schematic depiction of an example rocket engine and operation cycle thereof. The engine includes an aerospike expansion nozzle 38 and a thrust source 36. The aerospike expansion nozzle 38 has a first end 42 and a second end 44, an interior space 46, a fuel-cooled nozzle section 52 and an oxidizer-cooled nozzle section 54.

The aerospike expansion nozzle 38 may be referred to as being truncated. The truncated aerospike nozzle 38 is shortened in axial length (measured from the first end 42 to the second end 44) with respect to an ideal aerospike with a length of 100%, with the second end 44 being flat and substantially parallel to the first end 42 instead of extending to a point as in an ideal aerospike nozzle. Truncation may be defined by a percentage of axial length compared to an aerospike nozzle having an axial length of 100%, with the truncated aerospike nozzle 38 being a percentage of the axial length of an ideal aerospike nozzle, where X is the percentage of truncation of the aerospike nozzle 38. In some embodiments, the truncation of the aerospike nozzle 38 may have a truncation of approximately 32%, meaning that the axial length of the aerospike nozzle 38 is 32% of the axial length of an ideal aerospike nozzle. There is no “standard” length aerospike nozzle. 32% is an optimum axial length of the aerospike nozzle 38 described herein for a vacuum operation. In some embodiments, the axial length of the aerospike nozzle 38 can be less than 32%, for example at sea level for a booster application, but the performance of the aerospike nozzle 38 drops off in a vacuum at axial lengths less than 32%.

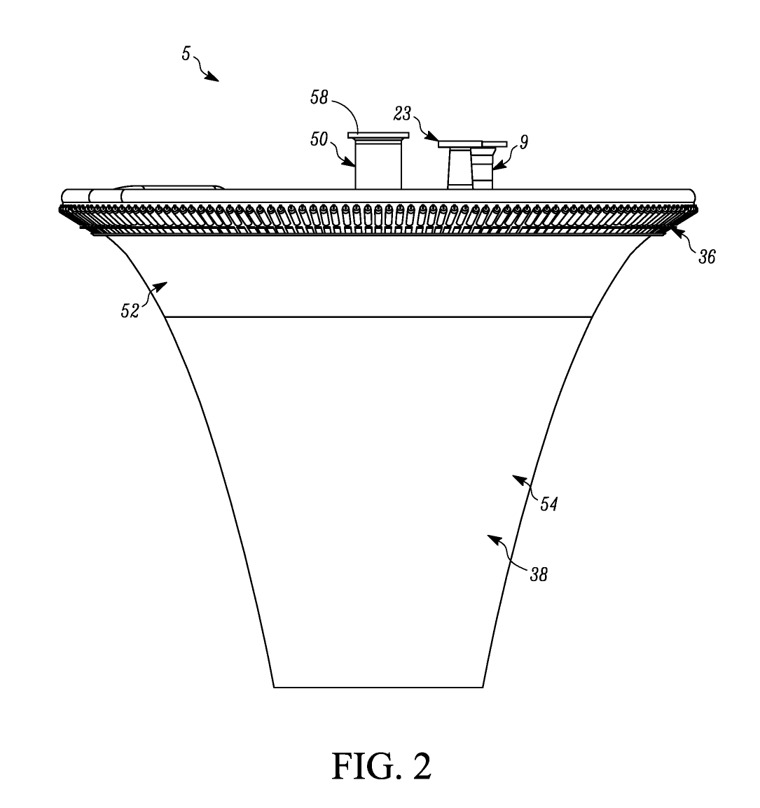

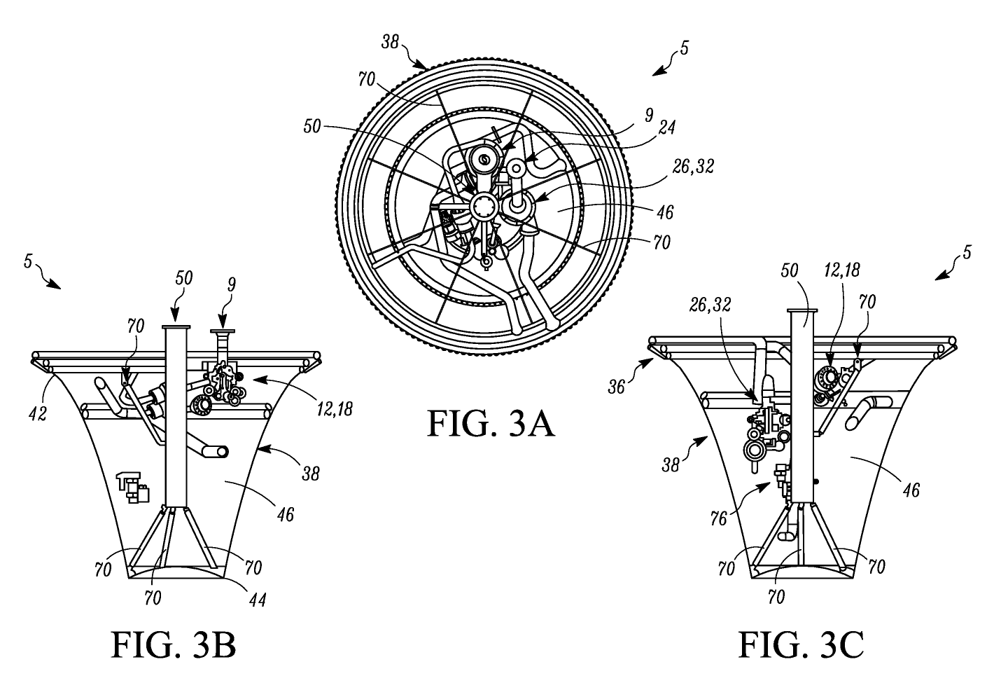

The first end 42 of the aerospike nozzle 38 is also wider than the second end 44 so that the aerospike nozzle 38 tapers in width from the first end 42 to the second end 44. FIG. 1 depicts the outer surface of the aerospike nozzle 38 as being flat between the ends 42, 44 so that the outer surface has a continuous linear taper. However, as shown in FIGS. 2, 3B and 3C, the outer surface of the aerospike nozzle 38 can be continuously curved from the first end 42 to the second end 44 so that the outer surface has a continuous arcuate taper. The outer surface could also be partially curved from the first end 42 to the second end 44 with a portion of the outer surface being curved and a portion being linear.

In addition, the aerospike nozzle 38 may be designed to have a high area ratio for expansion of the combustion gases from the thrust source 36 suitable for operation of the engine in a vacuum. In some embodiments, the aerospike nozzle 38 may be designed to provide an area ratio of approximately 231:1. The area ratio is defined as the outside diameter of the annular ring defined by the thrust source 36 divided by the sum of the throat areas of the modular thrust cells (when the thrust source 36 is formed by individual modular thrust cells as described further below), or the throat area when the thrust source is a continuous annular ring. The area ratio may be determined by computing a model of the expansion performance of the aerospike nozzle 38, for example using a one-dimensional equilibrium model of the expansion, and comparing that result to the area ratio required for a bell-nozzle engine to exhibit equivalent modeled expansion of the combustion gases.

The fuel-cooled nozzle section 52 defines one or more fluid passages in the wall of the aerospike nozzle 38. The fuel-cooled nozzle section 52 receives a fuel, such as liquid hydrogen, therein to exchange heat with the wall of the aerospike nozzle 38 and help cool the wall of the aerospike nozzle 38. As the fuel absorbs heat, the fuel expands prior to the fuel being directed into the thrust source 36 for combustion. Similarly, the oxidizer-cooled nozzle section 54 defines one or more fluid passages in the wall of the aerospike nozzle 38. The oxidizer-cooled nozzle section 54 receives an oxidizer, such as liquid oxygen, therein to exchange heat with the wall of the aerospike nozzle 38 and help cool the wall of the aerospike nozzle 38. As the oxidizer absorbs heat, the oxidizer expands prior to the oxidizer being directed into the thrust source 36 for combustion with the fuel.

In the illustrated example, the fuel-cooled nozzle section 52 is located between the first end 42 of the aerospike nozzle 38 and the oxidizer-cooled nozzle section 54, and the oxidizer-cooled nozzle section 54 is located between the fuel-cooled nozzle section 52 and the second end 44 of the aerospike nozzle. In addition, the fuel-cooled nozzle section 52 is downstream of the thrust source 36 so that combustion gases exhausted from the thrust source 36 heat the area of the wall of the aerospike nozzle 38 at the location of the fuel-cooled nozzle section 52. The oxidizer-cooled nozzle section 54 is also downstream of the thrust source 36 so that combustion gases exhausted from the thrust source 36 heat the area of the wall of the aerospike nozzle 38 at the location of the oxidizer-cooled nozzle section 54. However, other arrangements are possible. For example, the oxidizer-cooled nozzle section 54 could be located between the first end 42 of the aerospike nozzle 38 and the fuel-cooled nozzle section 52, and the fuel-cooled nozzle section 52 could be located between the oxidizer-cooled nozzle section 54 and the second end 44 of the aerospike nozzle, or the fuel-cooled nozzle section 52 and the oxidizer-cooled nozzle section 54 could partially or completely overlap one another between the ends 42, 44.

Still referring to FIG. 1, a fuel inlet 10 is in fluid communication with the fuel-cooled nozzle section 52 to permit introduction of fuel into the fuel-cooled nozzle section 52. A fuel outlet 11 in the aerospike nozzle 38 allows fuel to leave the fuel-cooled nozzle section 52. In addition, an oxidizer inlet 24 is in fluid communication with the oxidizer-cooled nozzle section 54 to permit introduction of oxidizer into the oxidizer-cooled nozzle section 54, and an oxidizer outlet 25 is formed in the aerospike nozzle 38 that allows oxidizer to leave the oxidizer-cooled nozzle section 54.

A fuel pump 12 is fluidly connected to the fuel inlet 10 to pump fuel into the fuel-cooled nozzle section 52. The fuel pump 12 can receive fuel, such as liquid hydrogen, from a source of fuel 13 such as a fuel tank. In addition, an oxidizer pump 26 is fluidly connected to the oxidizer inlet 24 to pump oxidizer into the oxidizer-cooled nozzle section 54. The oxidizer pump 12 can receive oxidizer, such as liquid oxygen, from a source of oxidizer 27 such as an oxidizer tank.

The fuel pump 12 is part of a first turbopump assembly that includes a turbine 18. The fuel pump 12 is a single-stage turbopump that is driven by the turbine 18. The fuel pump 12 is in fluid communication with the fuel inlet 10 to pump fuel into the hydrogen fuel-cooled nozzle section 52, and the turbine 18 is mechanically coupled to the pump 12, for example by a drive shaft and if required suitable gearing, so that the turbine 18 drives the pump 12. The flow of the fuel from the pump 12 into the fuel-cooled nozzle section 52 is controlled by a main fuel valve 14. The turbine 18 includes an inlet 80 that is in fluid communication with the fuel outlet 11 to receive fuel therefrom for driving the turbine 18, and an outlet 82 that is in fluid communication with an inlet 64 of the thrust source 36 for supplying fuel to the thrust source 36. A fuel turbine bypass valve 20 can be provided to regulate the amount of fuel passing through the turbine 18.

The oxidizer pump 26 is part of a second turbopump assembly that includes a turbine 32. The oxidizer pump 26 is a single-stage turbopump that is driven by the turbine 32. The oxidizer pump 26 is in fluid communication with the oxidizer inlet 24 to pump oxidizer into the oxidizer-cooled nozzle section 54, and the turbine 32 is mechanically coupled to the pump 26, for example by a drive shaft and if required suitable gearing, so that the turbine 32 drives the pump 26. The flow of the fuel from the pump 26 into the oxidizer-cooled nozzle section 54 is controlled by a main oxidizer valve 28 which regulates the amount of oxidizer entering the oxidizer-cooled nozzle section 54. The turbine 32 includes an inlet 84 that is in fluid communication with the oxidizer outlet 25 to receive oxidizer therefrom for driving the turbine 32, and an outlet 86 that is in fluid communication with an inlet 66 of the thrust source 36 for supplying oxidizer to the thrust source 36. An oxidizer turbine bypass valve 34 can be provided to regulate the amount of oxidizer entering turbine 32.

In some embodiments, the oxidizer pump 26, the fuel pump 12, the oxidizer turbine 32, and the fuel turbine 18 may feature common design elements such as using identical housings for the fuel pump 12 and the oxidizer pump 26, and identical housings for the fuel turbine 18 and the oxidizer turbine 32. In some embodiments, the fuel pump 12 and the fuel turbine 18, and the oxidizer pump 26 and oxidizer turbine 32 may use common flow paths, for example using identical inner and outer annular flow paths for providing fuel to the fuel-cooled nozzle section 52 of the aerospike nozzle 38 and providing oxidizer to the oxidizer-cooled nozzle 54 section of the aerospike nozzle 38, and for directing the fuel and the oxidizer from the outlets 11, 25 to the respective turbines 18, 32.

As described further below and best seen in FIGS. 3B and 3C, both the first turbopump assembly (including the pump 12 and the turbine 18) and the second turbopump assembly (including the pump 26 and the turbine 32) are disposed entirely within the interior space 46.

The thrust source 36 can take any form of a thrust source that can receive a fuel and an oxidizer, combust the fuel and oxidizer in a combustion chamber 60, and discharge combustion gas through a combustion gas outlet 62 that is in fluid communication with the combustion chamber 60 onto an outer surface of the aerospike nozzle 38. In one embodiment, the thrust source 36 can be a continuous annular structure mounted around the aerospike nozzle 38 at the first end 42 thereof. In another embodiment, the thrust source 36 can be formed by a plurality of individual modular thrust cells (shown in FIGS. 1 and 2) disposed on the aerospike nozzle 38 at or adjacent to the first end 42 and that surround the aerospike nozzle 38.

When individual modular thrust cells are used for the thrust source 36, each of the thrust cells can include a first inlet 64 for fuel and a second inlet 66 for oxidizer. Each of the thrust cells further includes the combustion chamber 60 that receives fuel from the first inlet 64 and oxidizer from the second inlet 66, and the combustion gas outlet 62 in fluid communication with the combustion chamber 60 and that discharges combustion gas onto an outer surface of the aerospike nozzle 38. Further information on the construction and operation of modular thrust cells is disclosed in U.S. application Ser. No. 14/212,974 which is herein incorporated by reference in its entirety. In embodiments using a plurality of the thrust cells, the number and distribution of the thrust cells may be based on factors such as thrust, nozzle area ratio and/or chamber pressures. In some embodiments, the thrust cells 36 may be cooled by the fuel and/or the oxidizer prior to the fuel and/or oxidizer being injected into the combustion chamber 60. For example, in some embodiments, each thrust cell can include a thrust cell cooling segment 22, within which the fuel is initially introduced and used to cool the thrust cell, for example by directing the fuel through a series of tubes in the surface surrounding the combustion chamber 60 and/or the combustion gas outlet 62. After the fuel passes through the thrust cell cooling segment 22, the fuel may then be introduced into the combustion chamber 60 of the thrust cell through one or more inlet openings in the combustion chamber 60.

In operation of the system illustrated in FIG. 1, fuel, such as liquid hydrogen, from the fuel source 13 is pumped from the fuel source 13 by the pump 12 and into the fuel-cooled nozzle section 52 to cool that section of the aerospike nozzle 38. Simultaneously or separately, oxidizer, such as liquid oxygen, from the oxidizer source 27 is pumped from the oxidizer source 27 by the pump 26 and into the oxidizer-cooled nozzle section 54 to cool that section of the aerospike nozzle 38. The amount of fuel and oxidizer supplied to the sections 52, 54 can be controlled by the valves 14, 28, respectively.

After cooling the section 52, the fuel exits the fuel outlet 11 and enters the turbine 18 via the inlet 80. The fuel drives the turbine 18, then exits the turbine 18 through the exit 82 and flows into the thrust source 36 via the inlet 64. The driving of the turbine 18 by the fuel then drives the pump 12. Similarly, after cooling the section 54, the oxidizer exits the oxidizer outlet 25 and then enters the turbine 32 via the inlet 84. The oxidizer drives the turbine 32, then exits the turbine 32 through the exit 86 and flows into the thrust source 36 via the inlet 66.

The fuel and the oxidizer entering the thrust source 36 are mixed and combusted in the combustion chamber 60, with the combustion gases them discharged through the combustion gas outlet 62 onto the outer surface of the aerospike nozzle 38 thereby generating the thrust for the engine.

FIGS. 2 and 3A-C illustrate an example aerospike engine 5 that employs the concepts illustrated in FIG. 1. In FIG. 2, the thrust source 36, for example the individual modular thrust chambers, are shown disposed in a ring surrounding the aerospike nozzle 38 at or adjacent to the first end 42 (see FIG. 1). An example extent of the fuel-cooled nozzle section 52 and the oxidizer-cooled nozzle section 54 are also illustrated. A fuel inlet 9, which would be connected to the fuel source 13 as described above for FIG. 1, leads to the inlet of the fuel pump 12 and an oxidizer inlet 23, which would be connected to the oxidizer source 27 as discussed above for FIG. 1, leads to the inlet of the oxidizer pump 26. The fuel and the oxidizer are pumped into the respective nozzle sections 52, 54 by the pumps 12, 26 which are disposed within the interior space 46 of the aerospike nozzle 38. During operation of the engine 5, the combustion gases emitted by the thrust source 36 pass over the surface of the fuel-cooled nozzle section 52 and the oxidizer-cooled nozzle section 54, with the combustion gases heating the outside surface of the aerospike nozzle 38. The fuel and the oxidizer in the nozzle sections 52, 54 absorb heat from the surface of the aerospike nozzle 38, thereby heating and expanding the fuel and the oxidizer. The expanded fuel and oxidizer are then directed through the turbines 18, 32 to power the pumps 12, 26, respectively.

FIGS. 2 and 3A-C also depicts the engine 5 as including a thrust mount 50. The thrust mount 50 is a fixture by which the engine 5 may be connected to a payload. The thrust mount 50 may be, for example, a pole or rod that is fixed to the engine 5 via a plurality of gimble mount rods 70 connecting the thrust mount 50 to the inside of the aerospike nozzle 38 as shown in FIGS. 3A-C. The gimbal mount rods 70 allow the orientation of the engine 5 to be adjusted relative to the payload. In addition, the thrust mount 50 may, for example, provide a lip 58 by which the payload is secured to the engine 5. However, other thrust mount configurations are possible.

In some embodiments, the mixture ratio of the fuel and the oxidizer may be controlled through control of the fuel valve 14 and the oxidizer valve 28. Each of the valves 14, 28 can be control valves that can be controllably set to a fully closed, fully open, or any partially open setting between fully open and fully closed. The valves 14, 28 control the thrust of the engine 5. If both of the valves 14, 28 are open simultaneously from one open setting to a higher open setting, the thrust will increase. If the opening percentage of one of the valves 14, 28 is increased and the opening percentage of the other valve is decreased, the mixture ratio is changed at the same thrust level. If only one valve is changed, the mixture ratio is changed, but the thrust changes slightly.

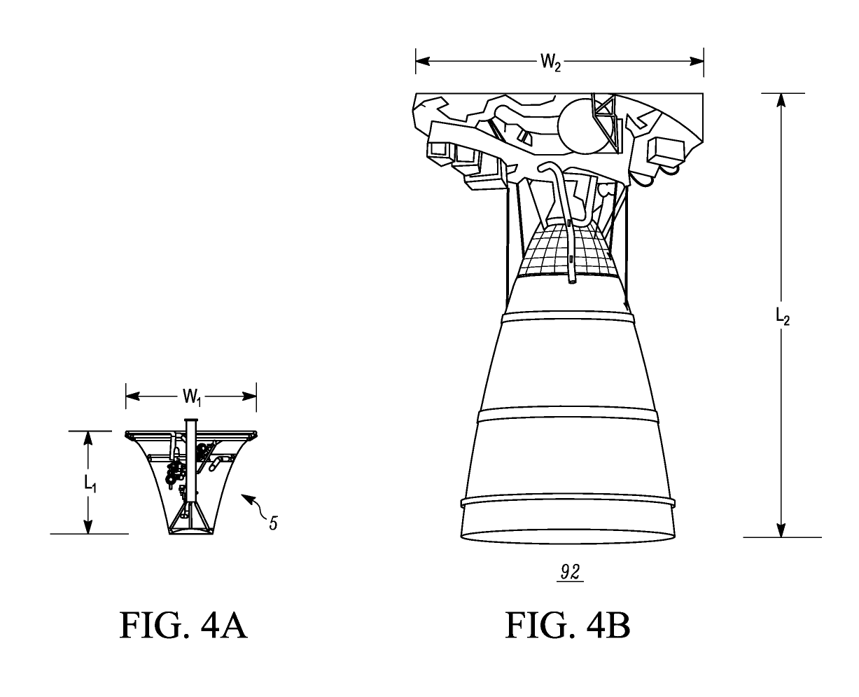

Referring to FIGS. 4A and 4B, a scale comparison of the engine 5 compared with a conventional, single-expander, bell-nozzle engine 92 such as the Pratt & Whitney RL-10B engine, is provided. The engine 5 has a length L₁ and a width W₁. The conventional engine 92 has a length L₂ that is significantly greater than the length L₁ of the engine, and a width W₂ that is significantly greater than the width W₁ of the engine 5. In addition, the engine 5 described herein can generate, for example, about 30 klbf of thrust in a vacuum, whereas the conventional engine 92 provides about 25 klbf thrust in vacuum.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A rocket engine, comprising:
a truncated aerospike nozzle having a first end and a second end, a fuel-cooled nozzle section between the first end and the second end, and an oxidizer-cooled nozzle section between the first end and the second end;
a fuel inlet that is in fluid communication with the fuel-cooled nozzle section to permit introduction of fuel into the fuel-cooled nozzle section;
a fuel outlet formed in the truncated aerospike nozzle that allows fuel to leave the fuel-cooled nozzle section;
an oxidizer inlet that is in fluid communication with the oxidizer-cooled nozzle section to permit introduction of oxidizer into the oxidizer-cooled nozzle section;
an oxidizer outlet formed in the truncated aerospike nozzle that allows oxidizer to leave the oxidizer-cooled nozzle section;
a fuel pump in fluid communication with the fuel inlet to pump fuel into the fuel-cooled nozzle section;
an oxidizer pump in fluid communication with the oxidizer inlet to pump oxidizer into the oxidizer-cooled nozzle section; and
a thrust source disposed on the truncated aerospike nozzle adjacent to the first end and that surrounds the truncated aerospike nozzle, the thrust source includes a first inlet that is in fluid communication with the fuel outlet and a second inlet that is in fluid communication with the oxidizer outlet; the thrust source has a combustion chamber that receives fuel from the first inlet and oxidizer from the second inlet, and a combustion gas outlet in fluid communication with the combustion chamber that discharges combustion gas onto an outer surface of the truncated aerospike nozzle.

2. The rocket engine of claim 1, wherein the truncated aerospike nozzle has an axial length of approximately 32% relative to an axial length of an ideal aerospike nozzle.

3. The rocket engine of claim 1, wherein the outer surface of the truncated aerospike nozzle has a combustion gas expansion effective area ratio of approximately 231:1.

4. The rocket engine of claim 1, further comprising:
a first turbine that is mechanically coupled to the fuel pump so that the first turbine drives the fuel pump, the first turbine includes an inlet that is in fluid communication with the fuel outlet and an outlet that is in fluid communication with the first inlet of the thrust source; and
a second turbine that is mechanically coupled to the oxidizer pump so that the second turbine drives the oxidizer pump, the second turbine includes an inlet that is in fluid communication with the oxidizer outlet and an outlet that is in fluid communication with the second inlet of the thrust source.

5. The rocket engine of claim 1, wherein the fuel pump is a single-stage turbopump and the oxidizer pump is a single-stage turbopump.

6. The rocket engine of claim 5, wherein the fuel is liquid hydrogen and the oxidizer is liquid oxygen.

7. The rocket engine of claim 1, wherein the thrust source comprises a plurality of thrust cells.

8. The rocket engine of claim 1, wherein the fuel-cooled nozzle section is located between the first end of the truncated aerospike nozzle and the oxidizer-cooled nozzle section, and the oxidizer-cooled nozzle section is located between the fuel-cooled nozzle section and the second end of the truncated aerospike nozzle.

9. A rocket engine, comprising:
a truncated aerospike nozzle having a first end and a second end, an interior space between the first end and the second end, a fuel-cooled nozzle section between the first end and the second end, and an oxidizer-cooled nozzle section between the first end and the second end;
a fuel inlet that is in fluid communication with the fuel-cooled nozzle section to permit introduction of fuel into the fuel-cooled nozzle section;
a fuel outlet formed in the truncated aerospike nozzle that allows fuel to leave the fuel-cooled nozzle section;
an oxidizer inlet that is in fluid communication with the oxidizer-cooled nozzle section to permit introduction of oxidizer into the oxidizer-cooled nozzle section;
an oxidizer outlet formed in the truncated aerospike nozzle that allows oxidizer to leave the oxidizer-cooled nozzle section;
a single-stage fuel turbopump in fluid communication with the fuel inlet to pump fuel into the fuel-cooled nozzle section, the single-stage fuel turbopump is disposed entirely within the interior space;
a single-stage oxidizer turbopump in fluid communication with the oxidizer inlet to pump oxidizer into the oxidizer-cooled nozzle section, the single-stage oxidizer turbopump is disposed entirely within the interior space; and
a plurality of thrust cells disposed on the truncated aerospike nozzle adjacent to the first end and that surround the truncated aerospike nozzle, each of the thrust cells includes a first inlet that is in fluid communication with the fuel outlet and a second inlet that is in fluid communication with the oxidizer outlet; each of the thrust cells further includes a combustion chamber that receives fuel from the first inlet and oxidizer from the second inlet, and a combustion gas outlet in fluid communication with the combustion chamber that discharges combustion gas onto an outer surface of the truncated aerospike nozzle.

10. The rocket engine of claim 9, wherein the truncated aerospike nozzle has an axial length of approximately 32% relative to an axial length of an ideal aerospike nozzle.

11. The rocket engine of claim 9, wherein the outer surface of the truncated aerospike nozzle has a combustion gas expansion effective area ratio of approximately 231:1.

12. The rocket engine of claim 9, further comprising:
a first turbine that is mechanically coupled to the single-stage fuel turbopump so that the first turbine drives the single-stage fuel turbopump, the first turbine includes an inlet that is in fluid communication with the fuel outlet and an outlet that is in fluid communication with the first inlets of the thrust cells; and
a second turbine that is mechanically coupled to the single-stage oxidizer turbopump so that the second turbine drives the single-stage oxidizer turbopump, the second turbine includes an inlet that is in fluid communication with the oxidizer outlet and an outlet that is in fluid communication with the second inlets of the thrust cells.

13. The rocket engine of claim 9, wherein the fuel is liquid hydrogen and the oxidizer is liquid oxygen.

14. The rocket engine of claim 9, wherein the fuel-cooled nozzle section is located between the first end of the truncated aerospike nozzle and the oxidizer-cooled nozzle section, and the oxidizer-cooled nozzle section is located between the fuel-cooled nozzle section and the second end of the truncated aerospike nozzle.

15. A rocket engine, comprising:
an aerospike nozzle having a first end and a second end, an interior space between the first end and the second end, a hydrogen fuel-cooled nozzle section between the first end and the second end, and an oxygen-cooled nozzle section between the first end and the second end;
a liquid hydrogen fuel inlet that is in fluid communication with the hydrogen fuel-cooled nozzle section to permit introduction of liquid hydrogen fuel into the hydrogen fuel-cooled nozzle section;
a hydrogen fuel outlet formed in the aerospike nozzle that allows hydrogen fuel to leave the hydrogen fuel-cooled nozzle section;
a liquid oxygen inlet that is in fluid communication with the oxygen-cooled nozzle section to permit introduction of liquid oxygen into the oxygen-cooled nozzle section;
an oxygen outlet formed in the aerospike nozzle that allows oxygen to leave the oxygen-cooled nozzle section;
a first turbopump assembly that includes a single-stage hydrogen turbopump and a first turbine, the single-stage hydrogen turbopump is in fluid communication with the liquid hydrogen fuel inlet to pump liquid hydrogen fuel into the hydrogen fuel-cooled nozzle section, and the first turbine is mechanically coupled to the single-stage hydrogen turbopump so that the first turbine drives the single-stage hydrogen turbopump;
a second turbopump assembly that includes a single-stage oxygen turbopump and a second turbine, the single-stage oxygen turbopump is in fluid communication with the liquid oxygen inlet to pump liquid oxygen into the oxygen-cooled nozzle section, and the second turbine is mechanically coupled to the single-stage oxygen turbopump so that the second turbine drives the single-stage oxygen turbopump,
the first turbopump assembly and the second turbopump assembly are disposed entirely within the interior space;
a plurality of thrust cells disposed on the aerospike nozzle adjacent to the first end and that surround the aerospike nozzle, each of the thrust cells includes a first inlet and a second inlet; each of the thrust cells further includes a combustion chamber that receives fuel from the first inlet and oxidizer from the second inlet, and a combustion gas outlet in fluid communication with the combustion chamber that discharges combustion gas onto an outer surface of the aerospike nozzle;
the first turbine includes an inlet that is in fluid communication with the hydrogen fuel outlet and an outlet that is in fluid communication with the first inlets of the thrust cells;
the second turbine includes an inlet that is in fluid communication with the oxygen outlet and an outlet that is in fluid communication with the second inlets of the thrust cells.

16. The rocket engine of claim 15, wherein the aerospike nozzle comprises a truncated aerospike nozzle with an axial length of approximately 32% relative to an axial length of an ideal aerospike nozzle.

17. The rocket engine of claim 15, wherein the outer surface of the aerospike nozzle has a combustion gas expansion effective area ratio of approximately 231:1.

18. The rocket engine of claim 15, wherein the hydrogen fuel-cooled nozzle section is located between the first end of the truncated aerospike nozzle and the oxygen-cooled nozzle section, and the oxygen-cooled nozzle section is located between the hydrogen fuel-cooled nozzle section and the second end of the truncated aerospike nozzle.
